(19) United States
(12) Patent Application Publication
(10) Pub. No.: US 2006/0149971 A1
(43) Pub. Date: Jul. 6, 2006

(54) Apparatus, method, and system to determine identity and location of a user with an acoustic signal generator coupled into a user-authenticating fingerprint sensor

(76) Inventor: Douglas Kozlay, Timonium, MD (US)

Correspondence Address: Douglas Kozlay, Suite 304, 9475 Deereco Road, Timonium, MD, 21093, US

(21) Appl. No.: 11/026,165

(22) Filed: Dec. 30, 2004

(51) Int. Cl. H04K 1/00

(52) U.S. Cl. 713/186

(57) ABSTRACT

An ergonomic, easy-to-use, device-independent, authenticator apparatus is disclosed. The authenticator of the present invention is used in conjunction with a communicating device such as a cellular telephone. The authenticator and the communicating device together are used to communicate a user's identity and location data to a tracking center. The authenticator apparatus itself includes a fingerprint sensor with a processor for enrolling user fingerprints and for subsequently authenticating enrolled user fingerprints. The processor also includes an acoustic signal generator function which is enabled by the fingerprint sensor, but only after successful authentication by the fingerprint sensor has been completed. The invention is particularly useful for monitoring persons who must remotely prove their location and identity to a centralized and/or distributed tracking and/or monitoring center.

### BACKGROUND

1. Field of the Invention

The field of the invention is biometric fingerprint sensors, more specifically, a biometric fingerprint sensor directly linked into an acoustic signal generator.

2. Related Art

U.S. Pat. No. 5,280,527 to Gullman, et al., discloses a security apparatus which obtains a biometric input from a user, which is compared to a template to determine a correlation factor. The correlation factor, a fixed code and either a time-varying code or a challenge code are combined to generate a token. The token is displayed to the user, who then enters the token at an access device. The access device is coupled to a secure host system. The access device forwards the token to the host, which processes the token to determine whether access is permitted. In one embodiment, the host is an electronic banking system. If access to such system is permitted the user is allowed to perform an electronic funds transfer. The security apparatus in one embodiment is an integrated circuit card. Each apparatus includes a sensor for detecting the holder's biometric information (i.e., voice, signature, fingerprint), along with a processor and display. The processor generates the token which then is displayed to the holder.

Although the Gullman patent and the products it protects provides a contribution to the art, the patent is silent on using a fingerprint sensor in conjunction with an acoustic signal pattern generator for the purpose of authenticating the identity and location of a user. Additionally, the Gullman patent does not mention any usage of a location determining device such as a GPS device and system.

U.S. Pat. No. 4,998,279 to Weiss discloses a credit card sized computer which generates a token from a secret “fixed” code (i.e., PIN) and a public “time-varying” code (i.e., time of day). Such token is displayed on the card so the user can enter the token to an access machine. The entry is done so as to combine the token with biometric information. For example, the token may be entered by having the user write the token numbers on a pressure-sensing pad or speak the token numbers into a telephone. The access verification system then compares the token to see if valid and compares the biometric input (e.g., voice or signature) to see if it has been transmitted from an authorized user.

Although the Weiss patent provides useful contribution to the art, there is no mention of a fingerprint sensor in conjunction with an acoustic signal pattern generator for the purpose of authenticating both the identity and location of a user. Additionally, the Weiss patent does not mention any usage of the GPS position-locating system. Furthermore, while the Weiss patent does make use of voice authentication, it is merely authenticating the voice of the user. By comparison, the present invention is verifying the fingerprint and location of the user.

U.S. Pat. No. 6,607,136 to Atsmon, et al., discloses a electronic card such as a credit card which can be used to transmit a signal over a telephone to a base station so that special reader hardware need not be installed to interact with the electronic card. The card receives and transmits data via sound waves.

The Atsmon patent is a contribution to the art, however, the Atsmon patent does not claim biometric authentication and is silent on the topic of a GPS position-locating system and a fingerprint sensor coupled to an acoustic signal generator. This patent also discloses his invention in the form factor of an electronic card, unlike the present invention.

### NECESSITY OF THE INVENTION

Use of biometric fingerprint sensors to authenticate users is well known in the art. Inventor has not seen any products having a device-independent fingerprint sensor which is directly linked into an acoustic signal generator.

Furthermore, it is very difficult if not impossible to electrically interface an authentication and tracking system into an existing cellular telephone without voiding the warranty and/or disturbing existing circuits.

Accordingly, there is a need in the art for a device to serve remote personnel monitoring applications. This need is served by means of biometric (fingerprint) authentication and an acoustic signal generator, in conjunction with remotely-monitored devices, such as cellular telephones and other communications devices, e.g., Personal Data Administrators (PDAs), “smart phones”, personal communicators (e.g., “Blackberry”™), beepers, radiotelephones, etc.

### OBJECTS OF THE INVENTION

Accordingly, it is one object of the present invention, to provide a device-independent biometric fingerprint sensor which is used to authenticate a user prior to enabling an acoustic signal generator.

It is another object, to provide an acoustic signal generator for generating different individual sound “signatures”, which correspond to different individual enrolled users, to authenticate and identify the identity and location of each such user in direct proximity to an assigned cellular telephone.

It is another object, to provide an attachable, easily moved, integrated “authenticator” module with a fingerprint sensor and with an acoustic signal generator and optionally with a GPS module (a location determining device), which can in some embodiments be easily moved by a user from one platform device (e.g., a communications device such as a telephone or a cell telephone or a beeper or a Personal Data Administrator (PDA) apparatus or other communicating device) to another platform device. Essentially this optional feature, lends itself to a standard fitting wherein a module could be “ported” from one device to another, by simply moving it from one standard fitting to another standard fitting.

It is yet another object, to provide a monitoring and tracking station capable of monitoring and tracking the authenticated identities and locations of persons using the attachable “authenticator” module containing the fingerprint sensor, the acoustic signal generator, and optionally a GPS module.

### SUMMARY OF THE INVENTION

The present invention is an easy-to-use, easy to deploy, highly portable, device-independent biometric fingerprint sensor directly coupled into an acoustic (sonic) signal generator and optionally additionally coupled either into a global positioning satellite (GPS) module (i.e., a location determining device) associated therewith and/or coupled into a cellular telephone or other communications device equipped with a GPS module. Each such acoustic signal generator can generate a unique “acoustic signature” that serves as a unique identifier signal pattern corresponding to each explicit individual user. In operation, the user being monitored is sent “into the field” into specific geographic locations and/or is sent out with specific geographic constraints for predetermined and agreed upon areas of their remote activity. The user, who is expected to remain within specific, predefined geographic limits and/or ranges, is periodically contacted by a person or automatic logging function responsible for monitoring the perambulations of the remote monitored user.

For example, in a probation release system application wherein a person is released on parole, the parolee user can be required to remain, e.g., within the geographic area comprising “City A”, and/or “specific suburbs of City A”, with the exception of areas demarcated by schools, playgrounds, and shopping malls. The parolee's compliance with this requirement can be verified periodically or randomly by prompting the user to provide a fingerprint authentication.

After successful authentication, the acoustic signal generator is enabled to generate a very specific, unique individual acoustic signature in the form of a sound pattern which corresponds to a “codeword” or “password” or “authentication proof” of the parolee. The remote location and identity process is further optimized, with the usage of a GPS module either in the “authenticator” module comprising the fingerprint sensor coupled to the acoustic signal generator, and/or with the use of a cellular telephone or other communicating device with GPS functionality.

### BRIEF DESCRIPTION OF THE DRAWINGS AND REFERENCE NUMERALS

### BRIEF DESCRIPTION OF THE DRAWINGS

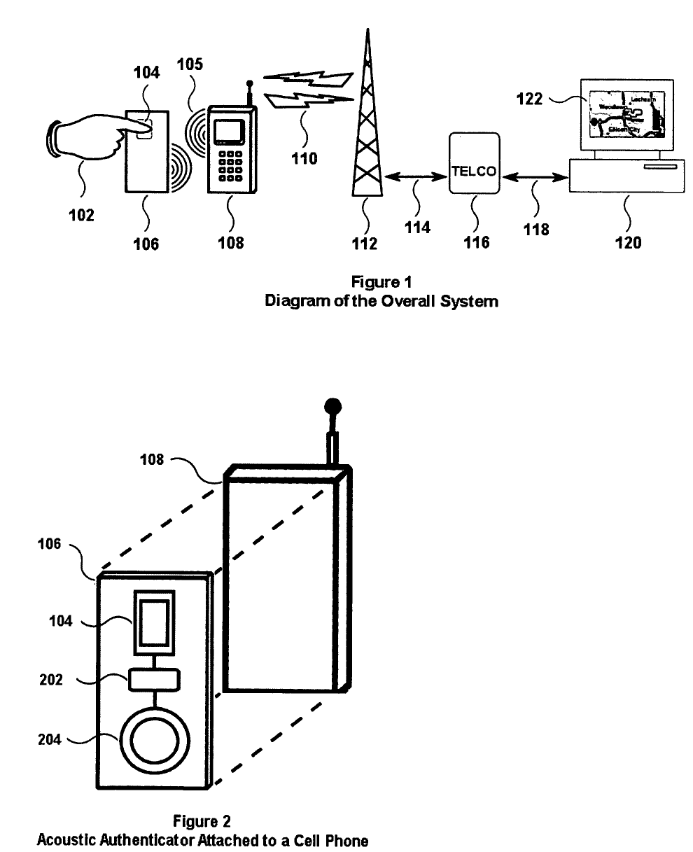

FIG. 1 shows an overview of the apparatus, method, and system of the present invention, from user fingerprint authentication through signal receiving at a tracking and monitoring station, such as a centrally located tracking and monitoring center.

FIG. 2 shows an overview of the authenticator apparatus of the present invention.

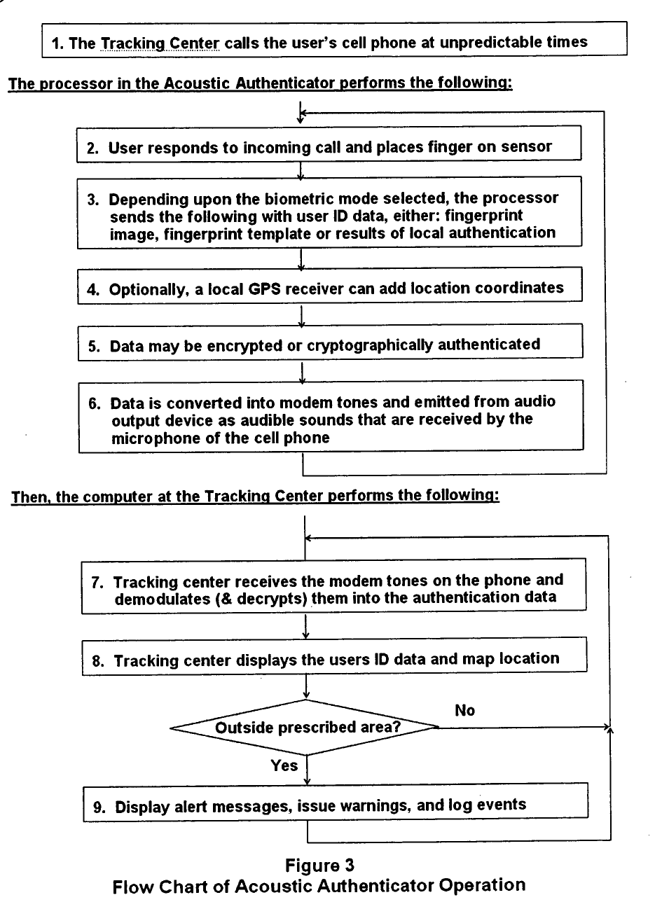

FIG. 3 depicts a flowchart showing one typical sequence of operations using the present invention.

### REFERENCE NUMERALS

102 User's hand with a finger placed on the electronic fingerprint sensor
104 Electronic fingerprint sensor
105 Acoustic waves
106 Acoustic authenticator
108 Cellular Telephone
110 Radio frequency transmission between cell phone and telco antenna
112 Cellular telephone company antenna
114 Ground link within cellular telephone company
116 Telephone company or cooperating companies
118 Subscriber link to the tracking center
120 Tracking center
122 Display of the authenticated user's position at tracking center
202 Processor within acoustic authenticator
204 Audio output device

### DETAILED DESCRIPTION OF THE INVENTION

Referring now to FIG. 1, an overview of the present invention is shown. When initially enrolling to use the invention—but prior to going into the field—the user 102 is directed to enroll his/her fingerprint(s) into a biometric sensor, e.g., fingerprint sensor 104 aboard authenticator apparatus 106. Also, along with authenticator 106—the user is additionally assigned a “communications device”, such as cellular telephone 108. Under most circumstances, both devices are operated together or in close proximity. The user, after receiving a prompt (or at their own initiative): authenticates at least one pre-enrolled fingerprint to the fingerprint sensor aboard authenticator apparatus 106, as explained in more detail in the discussion of FIG. 2, below.

After the user has successfully authenticated, authenticator 106 emits a digital signal which is modulated into an analog waveform which is in turn converted to audio tones by a sound generator. This digital signal further comprises the authentication information that is modulated to produce modem (modulator/demodulator) tones representing data to be sent to the microphone of cellular phone 108 (see FIG. 2 discussion). This data contains a signal that uniquely identities a “user” (e.g., a telephone user, smartcard user, card user, etc.) along with biometric data as described in FIG. 2 discussion, below. The audio signal is carried by the cell phone via radio link 110 to cell tower 112 and Telco 116, lines 114 and 118 to a subscriber who is the Tracking Center 120. At the Tracking Center, the audio signal is demodulated by a modem device or computer program to recover the original identity and user authentication data. If this data was encrypted and/or cryptographically authenticated by authenticator 106, it can be decrypted and cryptographically verified at the Tracking Station. The resulting data can be displayed 122 for an operator to view, or for alert messages to be generated for other parties, or for log entries made to a record, for example.

Alternatively, instead of using a cellular telephone, another communications channel or platform can be used, e.g., an automobile-based communications system, e.g., such as General Motors' ONSTAR™ System.

FIG. 2 shows a closer view of authenticator 106. The user places one or more finger(s) on the electronic sensor, 104 and a graphic image of the fingerprint is captured as is well known to the art. When the user presents their fingerprint(s) to the fingerprint sensor 104 aboard authenticator 106, processor 202 verifies the presented fingerprint(s) by comparison to its' (internal and/or external) fingerprint template database. This is known to the art, e.g, as in U.S. Pat. No. 4,582,985 to Lofberg, and many others. Assuming the presented fingerprint(s) “match”—and subsequent to the user successfully completing the step of fingerprint authentication—processor 202 generates transmittable data indicating the identity of the user and the results of the authentication.

After the user successfully completes biometric authentication (e.g., using fingerprint sensor 104 aboard authenticator 106), the authenticator 106 emits a digital signal which is modulated into an analog waveform which is in turn converted into audio tones by a sound generator. If the user is positively authenticated, the processor sends a data stream to the audio output device, such as described in the following examples:

Example of an identifying message (without cryptography) from the authenticator apparatus 106 to the tracking and monitoring center 120:
[Header, Device Serial Number, Authentication Result, Checksum]

Example of an identifying message (with encrypted data) from the authenticator apparatus 106 to the tracking and monitoring center 120:
[Header, ENCRYPTED (Device Serial Number, Authentication Result, Time-Varying Parameter), Checksum]

Example with challenge and cryptographic message authentication:

Challenge from center 120 to authenticator 106:
[Header, Time-Varying Challenge, Checksum]

Response from authenticator 106 to center 120
[Header, ENCRYPTED (Time-Varying Challenge, Device Serial Number, Authentication Result), Checksum]
   Definitions:

Header: A fixed data sequence to enable the recipient to recognize and synchronize with the message.

Device Serial Number: A unique number for each authenticator apparatus manufactured, which is installed at the factory or introduced at the time the device is issued to the user.

Authentication Result: An indication of the success or failure of an authentication event and optionally, an indication of the strength or certainty of that authentication (e.g., probability of positive match).

Checksum: A CRC (cyclic redundancy check) or other reliable means for detecting message errors, if any

Time-Varying Parameter: A number that changes over time and may optionally indicate the actual clock time at the transmitting authenticator device. NB: This is included to allow the center 120 to detect “replay” of previously-transmitted messages.

Time-Varying Challenge: An unpredictable number that is issued by the center 120 to be included in the encrypted or cryptographic response so as to prevent “replay” of old messages

Alternatively, the transmittable data can consist of the captured fingerprint image, itself, or a biometric template obtained from the fingerprint image. In any of these cases, the data is converted into a set of audio tones by modulating the audio signal to represent the binary data. This technique is well known to the art as “modern technology”, for example, as taught in U.S. Pat. No. 4,425,665 to Stauffer, and many others

The modulated signal is converted to sound by the acoustic (sonic) generator 204 which can be a small speaker or ceramic acoustic transponder. The sound reaches the cellular phone 108 either through the air by proximity to the cell phone's microphone or by conduction through the body of the phone due to direct contact. The cell phone transmits the modulated signal as described in the discussion of FIG. 1, above.

Referring now to FIG. 3, a flow chart of acoustic authenticator operation is illustrated, showing the basic “theory of operation” of the present invention. As has been already stated, the method of the invention can be either self-initiated by the user and/or initiated by a tracking and monitoring location, e.g., tracking center 120. This flowchart assumes that tracking center has initiated the call.

FIG. 3's flow chart Step 1 shows a tracking center 120 issuing a “prompt” (i.e., a telephone call or other type of “prompt”) to the user's cell phone 108 at random intervals or unpredictable intervals.

Next, Step 2 shows the user responding to the “prompt” (such as the call from tracking center 120 (shown). When prompted in this way, the user responds by pressing the answer button on cell phone 108 (not shown) and placing a previously-enrolled finger on the fingerprint sensor 104 of authenticator apparatus 106.

In Step 3, (depending on the configuration) the processor 202 either (a) compresses the fingerprint image into transmittable data (e.g., a unique acoustic signal which uniquely identifies each individual user); (b) extracts a template of the fingerprint image as transmittable data; or (c) in the preferred embodiment, executes an algorithm to authenticate the presented fingerprint against a stored template of the user's fingerprint, and if successful, generates a positive acknowledgement as transmittable data.

Step 4 shows cell phone 108 or processor 202 optionally obtaining a local GPS satellite (geographic location) “fix” as a user location determining mechanism, in addition to (e.g.) unique user name, unique device serial number and/or other unique data associated with the user, all for inclusion in one or more message data stream(s) modulated by the processor as part of the transmitted data transmitted to a monitoring and tracking station such as tracking center 120. Of course, this location determining device must be provisioned either within authenticator 106 and/or provisioned within the communicating device, e.g. a cell phone, PDA, etc.

Step 5 illustrates a security enhancement, wherein the transmitted data may be encrypted or cryptographically authenticated by the process to provide device authentication and protection against eavesdropping or data substitution attacks.

Step 6 shows the conversion of the transmittable data into modem (modulator/demodulator) tones and the emission from the audio output device 204 as audible sounds 105 that are received by the microphone of cell phone 108.

In Step 7, the tracking center 120 receives the audio authentication signal and decodes it (similar to decoding provided by a modem) into data that can be used to authenticate the individual.

In Step 8, the tracking center can display the received data and information and update the map location of the user.

Step 9 shows that if the user is found to be outside of an authorized or required geographic location, then alert messages can be displayed and issued to the appropriate personnel.

Based on the foregoing, it is readily observed by those skilled in the art, that many variations of the present invention are possible. Accordingly, the literal scope of this patent application and its' claims is not limited only to the disclosed embodiments and configurations disclosed herein.

I claim:

1. An authenticator apparatus for generating a unique acoustic signal for authenticating a user, comprising:
a fingerprint sensor for generating an image of at least one fingerprint of said user;
a processor coupled to said fingerprint sensor for executing a fingerprint authentication algorithm, wherein after successful completion of fingerprint authentication, said processor generates a message data stream identifying a successfully authenticated user, and wherein said processor further processes said message data stream to generate said unique acoustic signal further comprising a modulated message data stream suitable for transmission by a communicating device;
an audio output device coupled to said processor that emits said unique acoustic signal into said communicating device for communicating said unique acoustic signal to a tracking center; and
a power source.

2. The authenticator apparatus of claim 2, wherein said authenticator apparatus comprises a location determining device further comprising a global positioning satellite (GPS) receiver.

3. A system for communicating the identity and location of a least one user to at least one tracking center, comprising:
at least one authenticator apparatus for authenticating said at least one user and for generating a unique acoustic signal for authenticating said at least one user, further comprising a fingerprint sensor, a processor, an acoustic signal generator, an audio output device, and a power source;
at least one method for communicating said unique acoustic signal;
at least one communicating device for communicating said unique acoustic signal for authenticating said at least one user;
at least one location determining device for determining the location of said at least one communicating device for communicating said unique acoustic signal; and
said at least one tracking center for receiving and verifying the authenticity of said unique acoustic signal.

4. The system of claim 3, wherein said at least one location determining device further comprises a global positioning satellite (GPS) receiver coupled to said at least one authenticator apparatus.

5. The system of claim 3, wherein said at least one location determining device further comprises a global positioning satellite (GPS) receiver which is integral a cellular telephone and which can be interrogated by a tracking center.

6. The system of claim 3, wherein said at least one location determining device further comprises an external cellular telephone triangulation tracking system.

7. A method for communicating the identity and location of a user to a tracking center, comprising the steps of:
enrolling at least one fingerprint of said user into an authenticator apparatus comprising a fingerprint sensor including a processor coupled into an acoustic generator apparatus for generating a unique acoustic signal identifying the identity of a user;
prompting of said user by said tracking center to authenticate and communicate said user's identity and location by means of a communicating device;
authenticating said at least one fingerprint of said user;
enabling said acoustic signal generator;
generating said unique acoustic signal;
outputting said unique acoustic signal to said communicating device;
transmitting signals including said unique acoustic signal from said communicating device to a receiving device in said tracking center; and
verifying at said tracking center that said unique acoustic signal when demodulated correctly reproduces a verifiable data message suitable for identifying the user.

8. The method of claim 7, wherein said unique acoustic signal is comprised of a modulated data stream further comprising a series of modem tones representing digital information that identifies the user.

9. The method of claim 7, wherein means for verifying at said tracking center that said received signals were transmitted from an authorized location further comprises global positioning satellite (GPS) data received from said communicating device.

10. The method of claim 7, wherein means for verifying at said tracking center that said received signals were transmitted from an authorized location further comprises location signals from an external cellular telephone triangulation tracking system.

11. The method of claim 7, wherein said unique acoustic signal further comprises at least one of an encrypted message and a cryptographically authenticated message.

12. The apparatus of claim 1, wherein said authenticator apparatus is disposed within a module adapted for installation into a larger product.

13. The apparatus of claim 12, wherein said module is further adapted for installation into a communications device comprising at least one of a telephone and a cellular telephone and a beeper.

14. The apparatus of claim 12, wherein said module is further adapted for installation into a computer.

15. The apparatus of claim 12, wherein said module is adapted for installation into a computer communications device further comprising a Personal Data Assistant (PDA) apparatus.

16. The apparatus of claim 12, wherein said module is adapted for installation into at least one of a smartcard and a credit card and a debit card.

17. The apparatus of claim 12, wherein said module is adapted for installation into at least one of a keyfob and a watch and a ring.

18. The apparatus of claim 1, wherein said communications device further comprises an automobile communications system.
